(19) United States
(12) Patent Application Publication
(10) Pub. No.: US 2006/0280659 A1
(43) Pub. Date: Dec. 14, 2006

(54) Volatile liquid dispensing device

(75) Inventors: Colin Brown, Bracknell Berkshire (GB); Guy Edward Naish, Bicester Oxfordshire (GB)

Correspondence Address: NORRIS, MCLAUGHLIN & MARCUS, 875 THIRD AVE, 18TH FLOOR, NEW YORK, NY, 10022, US

(73) Assignee: Givaudan SA, Vernier (CH)

(21) Appl. No.: 10/554,626

(22) PCT Filed: Apr. 28, 2004
(86) PCT No.: PCT/CH04/00259

§ 371 Date: Oct. 26, 2005

(30) Foreign Application Priority Data
Apr. 30, 2003 (GB) 0309779.7

(51) Int. Cl. A62B 7/08

(52) U.S. Cl. 422/123; 422/124; 422/125

(57) ABSTRACT

A dispensing device (A) that includes an electrically driven actuator device (21) for dispensing a volatile liquid to an ambient environment comprising: a refill (10), which includes a reservoir of volatile liquid and a closure means (12); and a switch means associated (14) with the dispensing device adapted to engage or interact with the closure means when the dispensing device is appropriately assembled, such that an electrical circuit is completed and the device can operate. Only when the closure means of the refill properly engages or interacts with the switch means can the device be activated. If the closure means is improperly installed within the air treatment device, or if an inappropriate refill is installed, the electrical circuit remains open and the device does not

The present invention relates to improved dispensing devices. More particularly the present invention relates to dispensing devices useful for the delivery of a volatile or evaporable material to an ambient environment, such as a room, or interior of a vehicle.

Various devices useful for the delivery of volatile liquid materials such as fragrances, odour masking agents, insecticides and medicaments, are known in the art. One particular class of such devices is of those which are used for the delivery of a volatile liquid composition to an ambient environment. Typically, such devices include a reservoir from a neck of which reservoir protrudes a wick, which transports the liquid from the reservoir by means of capillary action to the ambient environment, into which it evaporates or volatilizes. Such devices are simple, and frequently effective. In certain embodiments, such devices are supplied as part of a larger apparatus, which may provide an external feature for static diffusion systems or it may include a means of diffusing the volatile liquid, such as a heat source, which may surround some or part of the wick, and which, when heated, induces more rapid volatilization of the liquid, or a fan that causes more rapid volatilization of the liquid into the ambient environment.

Such devices may be of a single-use type wherein they are provided to a consumer, who discards the complete air treatment device when the supply of volatile material has been exhausted, or they may be of a multi-use device wherein the consumer replaces only a refill in the air treatment device when the supply of volatile material has been exhausted. The multi-use type permits not only reuse, but also the flexibility of being able to use different liquids, if required

While such devices often effective, they are nonetheless not without shortcomings. One primary concern is the fact that the use of inappropriate refills in air treatment devices may provide a risk of malfunction, which may be annoying or even dangerous. Such inappropriate refills may, for instance, be refills produced by an unauthorized supplier, which may not meet the specific dimensions or the specific quality of appropriate refills, which are specifically designed and produced for use in the dispensing devices. The manufacture of air treatment devices requires precision in their design and assembly, and when of the multi-use type, the use of appropriate refills can be important to their optimal and safe performance. While the use of inappropriate refills is to be avoided due to the risk of malfunction, nonetheless consumers may inadvertently or inappropriately seek to use inappropriate refills in a multi-use type of air treatment device.

Accordingly, there is a need in the art for improved devices useful for the delivery of volatile materials such as fragrances, odour masking agents, insecticides, medicaments and other volatile materials, which improved devices provide a means for denying the use of inappropriate refills in an air treatment device.

In one aspect of the invention there is provided a dispensing device which includes an electrically driven actuator device for dispensing a volatile material to an ambient environment comprising:

a refill which includes a reservoir containing a volatile liquid and which further includes a closure means; and

a switch means associated with the dispensing device adapted to engage or interact with the closure means when the dispensing device is appropriately assembled.

When the closure means of the refill properly engages or interacts with the switch means of the dispensing device, an electrical circuit within the dispensing device may be activated. Such an electrical circuit may control a fan, blower, heating element, piezoelectric nebuliser or any other electrically-driven device, hereinafter referred to as an “actuator” which is useful in vaporizing or dispersing a volatile liquid. If the closure means is improperly installed within the air treatment device, or if an inappropriate refill is installed, the electrical circuit remains open and the electrically driven device does not operate.

A still further aspect of the invention is directed to a process for preventing the use of inappropriate refills in a dispensing device, especially an air treatment device.

The volatile liquid, which may be used in the dispensing devices taught herein, may be any volatile or evaporable material whose dissemination into an atmosphere is desired. These include fragrances, odour masking agents, insecticides, medicaments and other volatile materials.

In the case of liquids that have a cosmetic effect, such as a fragrancing or odour masking, particularly useful examples are those based on essential oils. Examples of useful essential oils include: anethole 20/21 natural, aniseed oil china star, aniseed oil globe brand, balsam (Peru), basil oil (India), black pepper oil, black pepper oleoresin 40/20, Bois de Rose (Brazil) FOB, borneol flakes (China), camphor oil, canaga oil (Java), cardamom oil, cassia oil (China), cedarwood oil (China), cinnamon bark oil, cinnamon leaf oil, citronella oil, clove bud oil, clove leaf, coriander (Russia), coumarin (China), cyclamen aldehyde, diphenyl oxide, ethyl vanillin, eucalyptol, eucalyptus oil, eucalyptus citriodoura, fennel oil, geranium oil, ginger oil, ginger oleoresin (India), white grapefruit oil, guaiacwood oil, gurjun balsam, heliotropin, isobornyl acetate, isolongifolene, juniper berry oil, L-methyl acetate, lavender oil, lemon oil, lemongrass oil, lime oil, litsea cubeba oil, longifolene, menthol, methyl cedryl ketone, methyl chavicol, methyl salicylate, musk ambrette, musk ketone, musk xylol, nutmeg oil, orange oil, patchouli oil, peppermint oil, phenyl ethyl alcohol, pimento berry oil, pimento leaf oil, rosalin, sandalwood oil, sandenol, sage oil, clary sage, sassafras oil, spearmint oil, spike lavender, tagetes, tea tree oil, vanilin, vetyver oil (Java), wintergreen.

These and other suitable materials, which may be useful in the volatile liquid, may be commercially obtained from a variety of suppliers including: Givaudan Corp. (Teaneck, N.J.); Berje Inc. (Bloomfield, N.J.); BBA Aroma Chemical Div. of Union Camp Corp. (Wayne, N.J.); Firmenich Inc. (Plainsboro N.J.); Quest International Fragrances Inc. (Mt. Olive Township, N.J.); Robertet Fragrances Inc. (Oakland, N.J.), or from other suppliers not necessarily listed herein.

The volatile liquids may be provided in the form of neat compositions, or they may be provided as aqueous mixtures, organic mixtures or aqueous-organic mixtures, which include one or more volatile or evaporable materials.

The dispensing device according to the invention may be used to dispense a volatile liquid in any ambient environment. Non-limiting examples of ambient environments include interior spaces of buildings or other structures such as rooms, hallways, elevators, common areas, closets, as well as the interior spaces of vehicles such as automobile interiors, boat interiors, aircraft cabins, and the like. The most preferred embodiments of the invention are air treatment devices.

The invention is now further described with reference to the drawings. These depict preferred embodiments and are not intended to limit the scope of the invention in any way.

FIG. 1 depicts a schematic view of an embodiment of the invention.

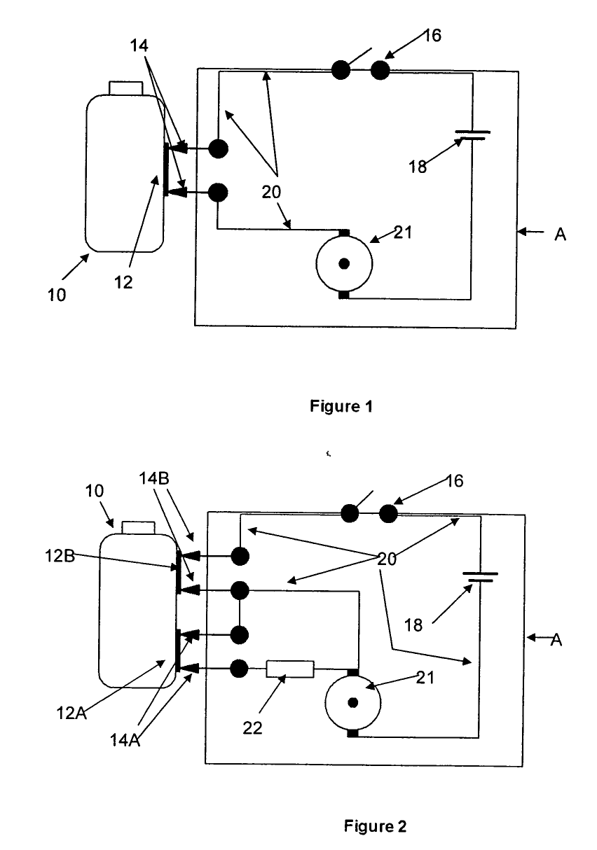

FIG. 2 depicts a schematic view of a further embodiment of the invention having plural switch means associated with the refill.

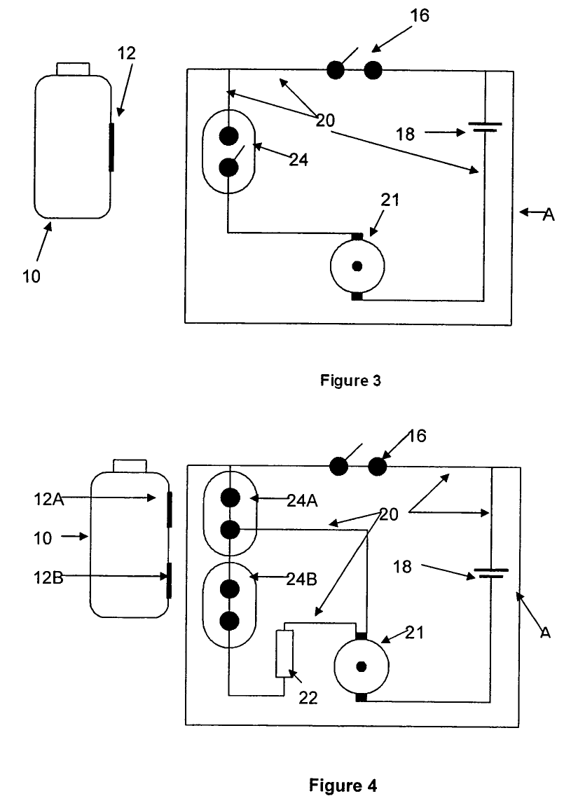

FIG. 3 depicts a schematic view of a further embodiment of the invention.

FIG. 4 depicts a schematic view of an alternate embodiment of the invention having plural switch means associated with the refill.

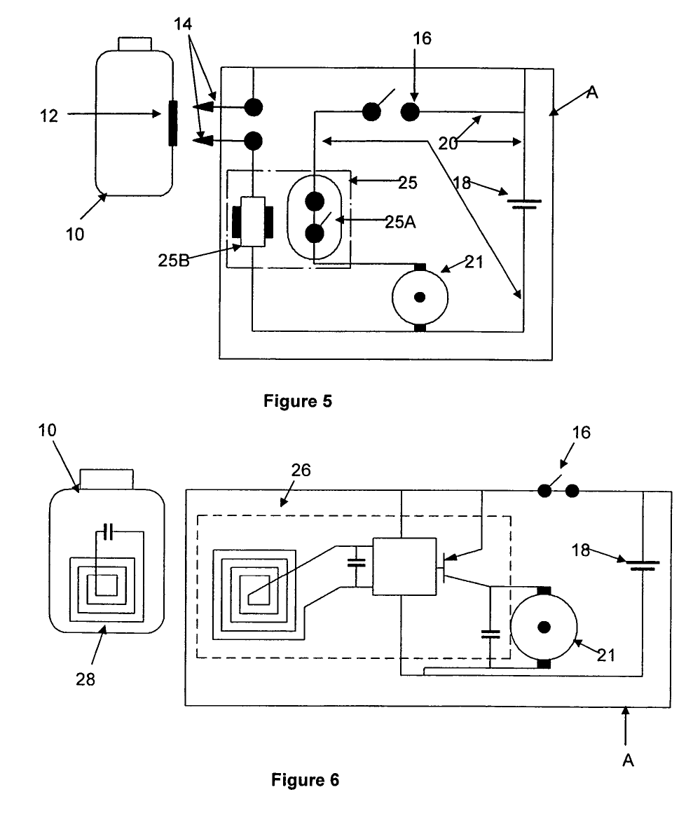

FIG. 5 depicts a schematic view of a further embodiment of the invention.

FIG. 6 depicts a schematic view of a still further embodiment of the invention.

In FIG. 1, a refill 10 containing a volatile liquid which emanates therefrom (either directly, or via a porous wick) has associated therewith a closure means, here in the form of an electrically conductive strip 12 adhered to the refill 10. The strip 12 is positioned at a specific location such that, when the refill 10 is properly installed in a dispensing device (represented by the rectangle “A”), the strip 12 engages switch means, here in the form of two metal contacts 14, which protrude from the housing of the dispensing device and may be used to close an electrical circuit. In the depicted embodiment, within the electrical circuit an (optional) power on/off switch 16 maybe used to interrupt the flow of current from a power source, here a battery 18, through a series of current conductors 20, usually insulated wires, through an actuator 21, which is useful in vaporizing or dispersing a volatile liquid. When the power on/off switch is in the “on” position and the refill 10 is properly installed in the dispensing device power is supplied to the actuator 20, but if the refill 10 is improperly installed or if an inappropriate refill is installed, the electrical circuit is interrupted and no electrical power is supplied to the actuator 20.

The embodiment of FIG. 2 comprises plural closure means 12A, 12B associated with the refill 10. Here, each closure means 12A and 12B is a separate electrically-conducting strip, each positioned at specific locations such that, when the refill 10 is properly installed in an dispensing device (not shown), each of the closure means 12A, 12B separately contact separate switch means 14A and 14B. Each of the switch means 14A, 14B is in the form of two metal contacts, which protrude from the housing of the dispensing device and which may be used to close separate electrical circuits. The completion of one circuit allows for the operation of the actuator 20 of the dispensing device, and completion of the second circuit diverts some of the available power through a current-limiting device, such as a resistor, capacitor or diode, which functions to control or modify the operation of the actuator. For example, the current-limiting device may cause the emanator to operate at a different speed where the emanator is a blower or a fan, or cause the emanator to operate at different temperature where the emanator is a heating element, or cause the emanator to operate at a different operating frequency where the emanator includes a piezoelectric element. While not shown, one or both of the closure means 12A, 12B may function as the current-limiting device and be used in place of the current-limiting device 22.

The embodiments according to FIGS. 1 and 2 provide a simple and effective form of a closure means which is inexpensive to produce, and may be easily applied to the exterior of a refill 10. For example, a conductive metallic tape or strip, or a metallised coating on a part of the exterior refill 10 provide inexpensive closure means.

FIG. 3 depicts a refill 10 whose closure means comprises a magnet 12 at a specific location, such that, when the refill 10 is properly installed in an dispensing device (represented by the rectangle “A” ), the magnet 12 engages switch means, here in the form of a reed switch 24, which responds to the position of the magnet. When the refill 10 is at some distance away from the dispensing device, or is improperly installed with the dispensing device, or if an inappropriate refill is installed, the reed switch 24 remains open, the electrical circuit is interrupted and no electrical power is supplied to the actuator 21. When an appropriate refill 10 is properly installed in the dispensing device, the magnet 12 operates to close the reed switch 24 and permit closure of the electrical circuit.

FIG. 4 depicts a schematic view of an alternative embodiment of the invention having two closure means 12A, 12B in the form of magnets associated with the refill 10. Here, each closure means 12A and 12B is positioned at a specific location such that, when the refill 10 is properly installed in an dispensing device (not shown), each of the closure means 12A, 12B separately cause individual switch means 14A and 14B, here in the form of reed switches, to close. As described with reference to FIG. 2, the completion of one circuit allows the operation of the actuator 21 of the dispensing device, and completion of the second circuit diverts some of the available power through a current-limiting device such as a resistor, capacitor or diode, which functions to control or modify the operation of the actuator.

The embodiments according to FIGS. 3 and 4 provide another simple and effective form of a closure means, which is inexpensive to produce, and which may be easily applied to the exterior of a refill 10. For example, a small magnet or a magnetic tape or strip provided to the exterior refill 10, or integrated into the construction of the refill 10 provides an inexpensive closure means. Further, no exposed switch means 14 are necessary, thereby providing an improved level of safety against accidental electrical shock or electrical discharge, as well as potential corrosion of the switch means 14.

The embodiment of FIG. 5 includes a refill 10 having associated therewith a closure means in the in the form of an electrically conductive strip 12 adhered to the refill 10. The strip 12 is positioned at a specific location, such that, when the refill 10 is properly installed in an dispensing device A, the strip 12 engages switch means, here two metal contacts 14, which protrude from the housing of the dispensing device A and which may be used to close an electrical circuit. The electrical circuit also includes a relay 25, which comprises an electromagnet 25A and a pair of contacts 25B. When an appropriate refill 10 is properly installed in the dispensing device thereby closing an electrical circuit, the electromagnet 25A is activated, causing contacts 25B to close and complete a second electrical circuit which supplies power to and allows for the operation of the actuator 20 of the dispensing device.

In FIG. 6, the switch means incorporates a radio frequency transmitter and receiver circuit 26 in the dispensing device A, and the closure means incorporates a metallic coil 28. The metallic coil 28 is of appropriate construction and dimensions such that, when a signal is transmitted from the radio frequency transmitter, the coil resonates in sympathy and emits a return resonant signal. This is received by the receiver, causing the switch means to function. If no resonant signal is returned, the switch means fails to function and no power is supplied to the actuator 20 of the dispensing device.

The embodiment according to FIG. 6 provides another simple and effective form of a closure means and a switch means, which, in addition to permitting operation of the dispensing device, may also be used to provide advanced control features. For example, the embodiment may permit the use of the dispensing device with metallic coils 28 of different dimensions, materials or configurations each of which may provide a different return resonant signal responsive to the radio frequency transmitter. The specific type of return resonant signal could be used to vary one or more of the operating characteristics of the dispensing device, particularly the operating characteristics of the actuator.

While not shown in FIG. 6, the closure means may be a radio frequency identification device, which may be preprogrammed with relevant information. In use, where the switch means incorporates a radio frequency transmitter and receiver circuit 26, the radio frequency identification device may transmit to the receiver circuit the relevant information, a portion of which may be used to activate the switch means and permit the operation of the actuator. Such radio frequency identification device may also provide further information to the receiver, e.g., manufacturer of the refill, type of volatile liquid, which further information may be used to modify the mode of operation of the actuator appropriately, to ensure that it is appropriate for the type of volatile liquid

The embodiments described in the figures are to be understood as being merely representative of the inventive teaching. It is contemplated that any form of the closure means and corresponding switch means could be used adapted for use in any of the other embodiments of the invention. Similarly, the inventive teaching can be used in dispensing devices that include a greater number of electrical circuits. It is clearly contemplated that, in addition to the actuator, further electrically-operated devices, such as timers, motors, motion sensors, light sensors, thermocouples, as well as any other current limiting or current controlling device, may be included in the dispensing devices. The use of various sources of electrical power necessary to operate the dispensing device are anticipated to include, e.g., rechargeable and non-rechargeable batteries, solar cells, automotive power supplies, as well as mains power either directly or via a step-down type transformer.

1. A dispensing device which includes an electrically driven actuator device for dispensing a volatile material to an ambient environment comprising:
a refill which includes a reservoir containing a volatile liquid and which further includes a closure means; and
a switch means associated with the dispensing device adapted to engage or interact with the closure means when the dispensing device is appropriately assembled.

2. A dispensing device according to claim 1 wherein the actuator device is a fan, blower, heating element, piezoelectric nebuliser or other electrically driven device useful in vaporizing or dispersing a volatile liquid.

3. A dispensing device according to claim 1 which comprises a plurality of closure means and a plurality of switch means.

4. A dispensing device according to claim 1 wherein the closure means is an electrically conductive strip or a magnet.

5. A dispensing device according to claim 1 wherein the switch means incorporates a radio frequency transmitter and receiver circuit.

6. A dispensing device according to claim 1 wherein the closure means incorporates a metallic coil which resonates and emits a return resonant signal.

7. A process for preventing the use of inappropriate refills in an air treatment device, which includes the step of:
providing a dispensing device according to claim 1 to an ambient environment.

8. A process for preventing the use of inappropriate refills in an air treatment device, which includes the step of:
providing a dispensing device according to claim 2 to an ambient environment.

9. A process for preventing the use of inappropriate refills in an air treatment device, which includes the step of:
providing a dispensing device according to claim 3 to an ambient environment.

10. A process for preventing the use of inappropriate refills in an air treatment device, which includes the step of:
providing a dispensing device according to claim 4 to an ambient environment.

11. A process for preventing the use of inappropriate refills in an air treatment device, which includes the step of:
providing a dispensing device according to claim 5 to an ambient environment.

12. A process for preventing the use of inappropriate refills in an air treatment device, which includes the step of:
providing a dispensing device according to claim 6 to an ambient environment.

13. A dispensing device according to claim 2 wherein the closure means is an electrically conductive strip or a magnet.

14. A dispensing device according to claim 3 wherein the closure means is an electrically conductive strip or a magnet.

15. A dispensing device according to claim 2 wherein the switch means incorporates a radio frequency transmitter and receiver circuit.

16. A dispensing device according to claim 3 wherein the switch means incorporates a radio frequency transmitter and receiver circuit.

17. A dispensing device according to claim 2 wherein the closure means incorporates a metallic coil which resonates and emits a return resonant signal.

18. A dispensing device according to claim 3 wherein the closure means incorporates a metallic coil which resonates and emits a return resonant signal.
